(19) United States
(12) Patent Application Publication
(10) Pub. No.: US 2020/0117257 A1
(43) Pub. Date: Apr. 16, 2020

(54) METHOD AND DEVICE FOR POWER CONTROL

(71) Applicant: Acer Incorporated, New Taipei City (TW)

(72) Inventors: Shuo-Jung Chou, New Taipei City (TW); Chuan-Jung Wang, New Taipei City (TW); Chih-Chiang Chen, New Taipei City (TW)

(73) Assignee: Acer Incorporated, New Taipei City (TW)

(21) Appl. No.: 16/459,496

(22) Filed: Jul. 1, 2019

(30) Foreign Application Priority Data
Oct. 12, 2018 (TW) 107213776

(51) Int. Cl. G06F 1/26; H02J 9/06; H02J 7/00

(52) U.S. Cl. CPC G06F 1/263; H02J 7/0026; H02J 9/061

(57) ABSTRACT

A power control device including a main battery, an auxiliary battery, a charging circuit, and a control circuit, for supplying power to a load is proposed. The main battery supplies power to the load. A volume, a capacity, and an output voltage of the auxiliary battery are all less than those of the main battery. The charging circuit receives a power input signal from a power supply network via a power adapter. The charging circuit generates a protection signal when changing from a first state that receives the power input signal to a second state that does not receive the power input signal. The control circuit controls the auxiliary battery to supply power to the load via a boosting circuit when receiving the protection signal, where a second output voltage outputted by the auxiliary battery is greater than or equal to a first output voltage outputted by the main battery.

### CROSS-REFERENCE TO RELATED APPLICATION

This application claims the priority benefit of Taiwan application serial no. 107213776, filed on Oct. 12, 2018. The entirety of the above-mentioned patent application is hereby incorporated by reference herein and made a part of this specification.

### TECHNICAL FIELD

The disclosure relates to a technique for power control.

### BACKGROUND

With a significant growth of the gaming market, gaming systems developed by manufacturers would pursue extreme performance to fulfill enthusiastic gamers' demands. However, the power consumption of a system would increase along with higher hardware performance. Therefore, portable devices with high performance such as high-performance gaming notebook computers would become popular in the market. To attain such purposes, when a portable device is connected to a power supply network (e.g. connected to a socket of a power supply network through a power adapter), it may operate in high efficiency. On the other hand, while a portable device is using a build-in battery for power supply, since the power supply capability of the battery is limited, the portable device may operate in low efficiency for power saving so as to prevent the system from unexpected shutdown due to insufficient power.

While the user is using a portable device, two power modes would be switched between. When the portable device changes from a mode that connects to the power supply network to a mode that receives power from a built-in battery, the built-in battery may not instantaneously provide sufficient power and thereby causing the system to shutdown unexpectedly.

To be specific, FIG. 1A and FIG. 1B respectively illustrate schematic wave diagrams of a voltage signal and a current signal of a conventional computer system with respect to time. A signal 110 represents a voltage of the system; a signal 120 represents a voltage of a protection mechanism provided by a charger; a signal 130 represents a voltage of a protection mechanism provided by software; and a signal 140 represents a current of the system. Herein, an AC-DC adapter is removed at time t. Since the charger and the software are under-throttling, the voltage of the system reduces to 3.8V, the power consumption of the system becomes 0, and the system is thereby shutdown unexpectedly. However, if the throttling process begins immediately after a sudden increment of the current of the system is detected to ensure that the system does not require a great amount of current that causes system shutdown, the user would then perceive noticeable difference in system performance.

### SUMMARY OF THE DISCLOSURE

Accordingly, a power control device and a power control method are proposed, where when a charging circuit stops receiving power, the user would be prevented from perceiving noticeable difference in system performance due to over-throttling, and a computer system would be prevented from unexpected shutdown due to under-throttling.

According to one of the exemplary embodiments, the power control device is for supplying power to a load and includes a main battery, an auxiliary battery, a boosting circuit, a charging circuit, and a control circuit. The main battery is configured to supply power to the load. A volume, a capacity, and an output voltage of the auxiliary battery are all less than those of the main battery. The boosting circuit is electrically connected to the auxiliary battery. The charging circuit is electrically connected to the main battery and the auxiliary battery and electrically connected to a power supply network via a power adapter to receive a power input signal from the power supply network and perform charging on the main battery and the auxiliary battery. The control circuit is electrically connected to the charging circuit, the boosting circuit, and the auxiliary battery. When the charging circuit changes from a first state that receives the power input signal to a second state that does not receive the power input signal, the charging circuit generates a protection signal. When the control circuit receives the protection signal, the control circuit controls the auxiliary battery to supply power to the load via the boosting circuit, where a second output voltage outputted by the auxiliary battery is greater than or equal to a first output voltage outputted by the main battery.

According to one of the exemplary embodiments, the power control method is applicable to a power control device having a main battery, an auxiliary battery, a boosting circuit, a charging circuit, and a control circuit, where the power control device is for supplying power to a load, and where a volume, a capacity, and an output voltage of the auxiliary battery are all less than those of the main battery. The power control method includes the following steps. A protection signal from the charging circuit is detected by the control circuit, where the charging circuit is electrically connected to a power supply network via a power adapter to receive a power input signal from the power supply network and perform charging on the main battery and the auxiliary battery, where the charging circuit generates the protection signal when the charging circuit changes from a first state that receives the power input signal to a second state that does not receive the power input signal. When the control circuit detects the protection signal from the charging circuit, the auxiliary battery is controlled by the control circuit to supply power to the load via the boosting circuit by the control circuit, where a second output voltage outputted by the auxiliary battery is greater than or equal to a first output voltage outputted by the main battery.

In order to make the aforementioned features and advantages of the present disclosure comprehensible, preferred embodiments accompanied with figures are described in detail below.

It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A illustrates a schematic wave diagram of a voltage signal of a conventional computer system with respect to time.

FIG. 1B illustrates a schematic wave diagram of a current signal of a conventional computer system with respect to time.

FIG. 2A illustrates a block diagram of a computer system in accordance with one of the exemplary embodiments of the disclosure.

FIG. 2B illustrates a block diagram of an auxiliary battery in accordance with one of the exemplary embodiments of the disclosure.

FIG. 3 illustrates a flowchart of a power control method in accordance with one of exemplary embodiments of the disclosure.

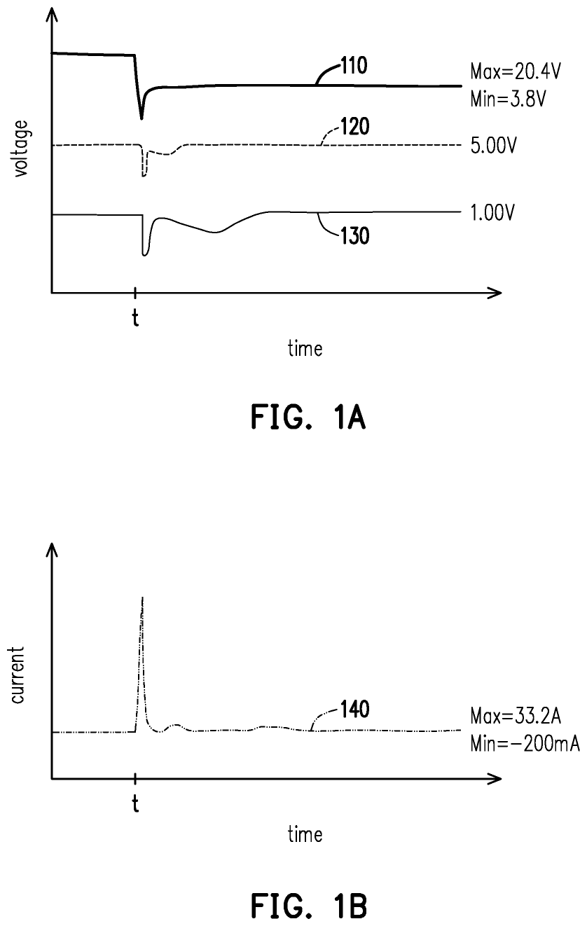

To make the above features and advantages of the application more comprehensible, several embodiments accompanied with drawings are described in detail as follows.

### DESCRIPTION OF THE EMBODIMENTS

Some embodiments of the disclosure will now be described more fully hereinafter with reference to the accompanying drawings, in which some, but not all embodiments of the application are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

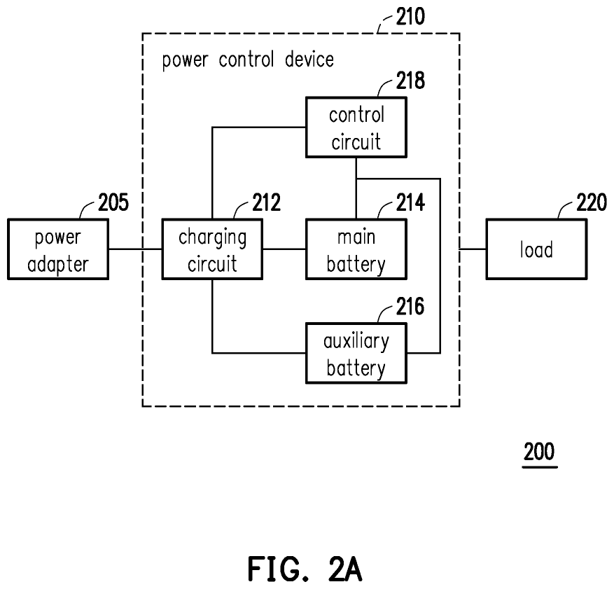

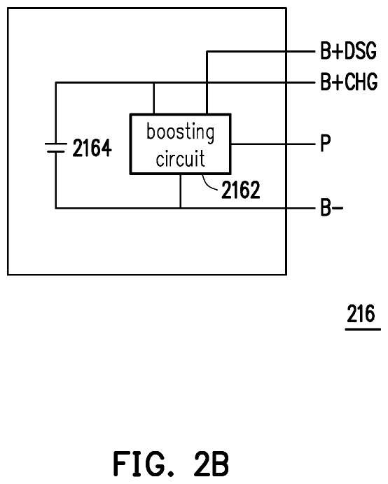

FIG. 2A illustrates a block diagram of a computer system in accordance with one of the exemplary embodiments of the disclosure. For simplicity purposes, some components of the computer system are not shown in FIG. 2A.

Referring to FIG. 2A, a computer system 200 would include a power adapter 205, a power control device 210, and a load 220. The computer system 200 may be a portable device such as a notebook computer, a tabular computer, a smart phone, and so forth.

In the present exemplary embodiment, the power adapter 205 with one end connected to a socket of a power supply network and another end connected to the power control device 210 may provide an alternating-current to direct-current (AC-DC) conversion function or a DC-DC conversion function. In another exemplary embodiment, the power adapter 205 may be a form of a vehicle adapter, a mobile power adapter, and so forth.

In the present exemplary embodiment, the power control device 210 would include a charging circuit 212, a main battery 214, an auxiliary batter 216, and a control circuit 218. The charging circuit 212 would be electrically connected to the main battery 214 and the auxiliary battery 216, and the control circuit 218 would be electrically connected to the charging circuit 212, the main battery 214, and the auxiliary battery 216. The charging circuit 212 includes an adapter socket configured to receive input power from the power adapter 205 to perform charging on the main battery 214 and the auxiliary battery 216. The main battery 214 and the auxiliary battery 216 may be a lithium-ion rechargeable battery, and its details would be provided later on. The control circuit 218 may be a chip or an integrated circuit component, such as an embedded controller (EC), a microcontroller, a power management integrated circuit (PMIC), to manage and operate the power control device 210.

In the present exemplary embodiment, the components in the computer system 200 that require power supply from the power control device 210 would be illustrated as a load 220 for simplicity purposes. The load 220 would be electrically connected to the power control device 220 and may include a motherboard, a processor, a graphics card, a hard disk drive, a screen display, and so forth.

In the present exemplary embodiment, a notebook computer would be an example of the computer system 200. The power control device 210 and the load 220 would be within a housing of the notebook computer, and the power adapter 205 would be able to be plugged into or removed from the charging circuit 212 of the power control device 210.

In the present exemplary embodiment, the main battery 214 would include a first quantity of battery cells. The battery cells may be 18650 lithium-ion battery cells or with any other suitable specifications. For example, when a single battery cell is able to provide 3.7V of output voltages and when the main battery 21 requires to provide 14V of output voltages, the main battery 214 would then include four serially-connected 3.7V battery cells to provide 14.8V of output voltages. The auxiliary battery 216 would include a second quantity of battery cells, where the second quantity is less than the first quantity for space-saving purposes. For example, the auxiliary battery 216 would include only one single 3.7V battery for volume saving. Take a block diagram of the auxiliary battery 216 as illustrated in FIG. 2B in accordance with one exemplary embodiment of the disclosure as an example. The auxiliary battery 216 may include a boosting circuit 2162, battery cells 2164, a boosting enable pin P, a ground pin B−, a charging pin B+CHG, and a discharging pin B+DSG. The control circuit 218 may transmit an enable signal to the enable pin P to operate the auxiliary battery 216. The control circuit 218 may generate the enable signal according to a change between a low-voltage signal and a high voltage signal. After the control circuit 217 enables the auxiliary battery 216, since the quantity of the battery cells 2164 is fewer, the boosting circuit 2162 would be used to control the output voltage of the auxiliary battery 216 to be greater than or equal to that of the main battery 214 so as to prevent the main battery 214 from requesting power supply from the auxiliary battery 216. Herein, the auxiliary battery 216 would obtain power supply from the charging circuit 212 via the charging pin B+CHG and perform charging on the battery cells 2164 as well as supply power to the load 220 via the discharging pin B+DSG. As a side note, FIG. 2B is merely one of exemplary embodiments. In other exemplary embodiments, the boosting circuit may not be included in the auxiliary battery, but may be electrically connected to the auxiliary battery to control the output voltage of the auxiliary battery to be greater than or equal to that of the main battery.

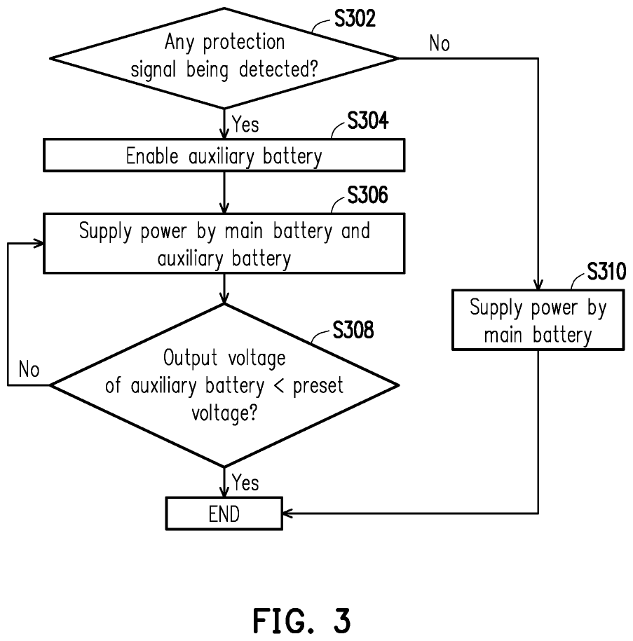

FIG. 3 illustrates a flowchart of a power control method in accordance with one of exemplary embodiments of the disclosure. The flow in FIG. 3 would be applicable to the computer system 200 in FIG. 2A.

Referring to FIG. 2A, FIG. 2B, and FIG. 3, the control circuit 218 of the power control device 210 would detect a protection signal from the charging circuit 212 (Step S302). Herein, the protection signal would be a response of an over-current event in the computer system 200. As an example of a narrow voltage direct current (NVDC) charger, the protection signal would be a PROCHOT signal. The protection signal may be triggered when the charging circuit 212 stops receiving power from the power adapter 205, e.g. when the power adapter 205 is removed from the charging circuit 212 or when power failure occurs. In another exemplary embodiment, the protection signal may be generated when firmware or software of the computer system 200 detects that a power input signal of the power supply network has disappeared. From another perspective, when the charging circuit 212 would generate the protection signal when changing from a first state that receives the power input signal to a second state that does not receive the power input signal.

The control circuit 218 would enable the auxiliary battery 216 via the boosting enable pin P when detecting the protection signal (Step S304) to supply power to the load 220 by the main battery 214 and the auxiliary battery 216 (Step S306), thereby preventing the user from perceiving noticeable difference in system performance due to over-throttling as well as preventing the computer system 200 from unexpected shutdown due to under-throttling.

During the discharging process of the main battery 214 and the auxiliary battery 216, the control circuit 218 would determine whether output voltage of the auxiliary battery 216 is less than a preset voltage value (Step S308), where the preset voltage value may be, for example 3V. If the determination is affirmative, the control circuit 218 would disable the auxiliary battery 216 and terminate the power control process. On the other hand, when the control circuit 218 does not detect any protection signal, it would not enable the auxiliary 216. That is, the control circuit 218 would supply power to the load 220 only by the main battery 214 as in an ordinary approach (Step S310) and terminate the power control process.

In summary, the device and the method for power control proposed in the disclosure would supply power to a load by using a main battery and an auxiliary battery when a charging circuit stops receiving power. As such, the user would be prevented from perceiving noticeable difference in system performance due to over-throttling, and a computer system would be prevented from unexpected shutdown due to under-throttling, thereby enhancing the user experience.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A power control device for supplying power to a load, comprising:
a main battery, configured to supply power to the load;
an auxiliary battery, wherein a volume, a capacity, and an output voltage of the auxiliary battery are all less than those of the main battery;
a boosting circuit, electrically connected to the auxiliary battery;
a charging circuit, electrically connected to the main battery and the auxiliary battery and electrically connected to a power supply network via a power adapter, configured to receive a power input signal from the power supply network and perform charging on the main battery and the auxiliary battery; and
a control circuit, electrically connected to the charging circuit, the boosting circuit, and the auxiliary battery, wherein:
in response to the charging circuit changing from a first state that receives the power input signal to a second state that does not receive the power input signal, the charging circuit generates a protection signal; and
in response to the control circuit receiving the protection signal, the control circuit controls the auxiliary battery to supply power to the load via the boosting circuit, wherein a second output voltage outputted by the auxiliary battery is greater than or equal to a first output voltage outputted by the main battery.

2. The power control device according to claim 1, wherein the main battery comprises a first quantity of battery cells, wherein the auxiliary battery comprises a second quantity of battery cells, and wherein the first quantity is greater than the second quantity.

3. The power control device according to claim 1, wherein in response to the second output voltage being less than a preset voltage value, the control circuit controls the auxiliary battery to stop supplying power to the load.

4. The power control device according to claim 1, wherein in response that the charging circuit stops receiving power from the power adapter, the charging circuit generates the protection signal.

5. The power control device according to claim 1, wherein in response that a power input signal of the power supply network is detected to disappear, the charging circuit generates the protection signal.

6. The power control device according to claim 1, wherein in response to the control circuit not receiving the protection signal, the control circuit controls only the main battery.

7. The power control device according to claim 1, wherein the auxiliary battery further comprises:
a charging pin, configured to obtain power supply from the charging circuit; and
a discharging pin, configured to supply power to the load.

8. The power control device according to claim 1, wherein the charging circuit is a narrow voltage direct current (NVDC) charger, and wherein the protection signal is a PROCHOT signal.

9. The power control method, applicable to a power control device having a main battery, an auxiliary battery, a boosting circuit, a charging circuit, and a control circuit, wherein the power control device is for supplying power to a load, wherein a volume, a capacity, and an output voltage of the auxiliary battery are all less than those of the main battery, and wherein the power control method comprises:
detecting a protection signal from the charging circuit by the control circuit, wherein the charging circuit is electrically connected to a power supply network via a power adapter to receive a power input signal from the power supply network and perform charging on the main battery and the auxiliary battery, wherein the charging circuit generates the protection signal in response to the charging circuit changing from a first state that receives the power input signal to a second state that does not receive the power input signal;
controlling the auxiliary battery by the control circuit to supply power to the load via the boosting circuit in response to the control circuit detecting the protection signal from the charging circuit, wherein a second output voltage outputted by the auxiliary battery is greater than or equal to a first output voltage outputted by the main battery.

10. The power control method according to claim 9, wherein the main battery comprises a first quantity of battery cells, wherein the auxiliary battery comprises a second quantity of battery cells, and wherein the first quantity is greater than the second quantity.

11. The power control method according to claim 9 further comprising:
controlling the auxiliary battery to stop supplying power to the load by the control circuit in response to the second output voltage being less than a preset voltage value.

12. The power control method according to claim 9 further comprising:
in response that the charging circuit stops receiving power from the power adapter, generating the protection signal by the charging circuit.

13. The power control method according to claim 9, wherein in response that a power input signal of the power supply network is detected to disappear, generating the protection signal by the charging circuit.

14. The power control method according to claim 9 further comprising:
controlling only the main battery by the control circuit to supply power to the load in response to the control circuit not detecting the protection signal, the control circuit controls only the main battery.

15. The power control method according to claim 9, wherein the auxiliary battery further comprises a charging pin and a discharging pin, and wherein the power control method further comprises:
obtaining power supply by the charging pin of the auxiliary battery from the charging circuit; and
supplying power by the discharging pin of the auxiliary battery to the load.
